(19) United States
(12) Patent Application Publication
(10) Pub. No.: US 2026/0154812 A1
(43) Pub. Date: Jun. 4, 2026

(54) RADIOMICS-BASED PREDICTION OF SEVERE IMMUNE-RELATED ADVERSE EVENTS IN PATIENTS WITH LUNG CANCER

(71) Applicant: H. LEE MOFFITT CANCER CENTER AND RESEARCH INSTITUTE INC., Tampa, FL (US)

(72) Inventors: Robert GILLIES, Tampa, FL (US); Matthew SCHABATH, Tampa, FL (US)

(21) Appl. No.: 19/123,276

(22) PCT Filed: Dec. 6, 2023
(86) PCT No.: PCT/US2023/082705

§ 371 Date: Apr. 22, 2025

Related U.S. Application Data
(60) Provisional application No. 63/386,176, filed on Dec. 6, 2022.

(51) Int. Cl. G06T 7/00

(52) U.S. Cl. CPC G06T 7/0012; G06T 2207/10081; G06T 2207/10104; G06T 2207/30061; G06T 2207/30096

(57) ABSTRACT

Disclosed herein are methods for identifying patients at risk for severe immune-related adverse events before the start of immunotherapy, which can optimize patient management and treatment planning and alleviate future complications with early interventions. This can involve analyzing ¹⁸F-FDG PET/CT images of a patient to determine PET features, CT features, and Kulbek Leibler Divergence (KLD) features from KLD images generated from the PET and CT images based upon KLD criteria, and computing a modified radiomic score (MRS) based on the radiomic signature that is predictive of severe immune-related adverse events in the patient.

### CROSS-REFERENCE TO RELATED APPLICATIONS

This application claims benefit of U.S. Provisional Application No. 63/386,176, filed Dec. 6, 2022, which is hereby incorporated herein by reference in its entirety.

### STATEMENT OF GOVERNMENT INTEREST

This invention was made with Government Support under Grant Nos. CA143062 and CA 190105 awarded by the National Institutes of Health. The Government has certain rights in the invention.

### BACKGROUND OF THE INVENTION

In the United States, lung cancer is the second most commonly diagnosed cancer and the leading cause of cancer-related deaths. There have been only small improvements in 5-year survival among patients with lung cancer, primarily due to high rates of late-stage detection, for which the survival rates are dismal. Until the advent of immunotherapy, there were limited treatment options for patients with late-stage non-small cell lung cancer (NSCLC). Among the many immunotherapeutic strategies, immune checkpoint blockade agents targeting the immunosuppressive molecules cytotoxic T-lymphocyte-associated protein 4 (CTLA-4), programmed cell death protein (PD-1), and its ligand PD-L1 have shown significant clinical benefit in treatment of late-stage NSCLC. However, checkpoint blockade can lead to development of autoimmune manifestations, leading to immune-related adverse events (irAEs). For patients with severe irAEs (irSAEs), treatment with immune checkpoint blockades should be avoided or discontinued. Therefore, identifying patients at risk for irSAEs before the start of immunotherapy is an unmet need that could optimize patient management and treatment planning and alleviate future complications with early interventions.

### SUMMARY OF THE INVENTION

Disclosed herein is a method that involves analyzing ¹⁸F-FDG PET/CT images of a patient to determine PET features, CT features, and Kulbek Leibler Divergence (KLD) features from KLD images generated from the PET and CT images based upon KLD criteria; and computing a modified radiomic score (MRS) based on the radiomic signature that is predictive of severe immune-related adverse events (irSAE) in the patient, the MRS determined based upon

$$MRS = - A \times CT\_GLN - B \times CT\_GS - C \times CT\_ZP + D \times KLD\_SZLGE - E \times KLD\_SRLGE + F ,$$

where CT_GLN is a grey-level nonuniformity determined from a grey level size zone matrix (GLSZM) indicating a number of groups of connected voxels with a common discretised grey level value and size, CT_GS is a means genometric symmetry determined from a texture spectrum matrix utilizing the CT features, CT_ZP is a zone percentage determined from the GLSZM utilizing the CT features, KLD_SZLGE is a small zone low gray level emphasis determined from the GLSZM utilizing KLD fusion images, and KLD_SRLGE is a short run low gray level emphasis determined from a grey level run length matrix (GLRLM) utilizing the KLD fusion images, and where A, B, C, D, E and F are constants with A in a range from about 0.74 to about 0.78, B in a range from about 0.75 to about 0.79, C in a range from about 0.59 to about 0.63, D in a range from about 1.29 to about 1.33, E in a range from about 0.37 to about 0.41, and F in a range from about 0.93 to about 0.97.

Also disclosed is a non-transitory computer-readable storage device storing computer-executable instructions that when executed cause processing circuitry to at least: analyze ¹⁸F-FDG PET/CT images of a patient to determine PET features, CT features, and Kulbek Leibler Divergence (KLD) features from KLD images generated from the PET and CT images based upon KLD criteria; and compute a modified radiomic score (MRS) based on the radiomic signature that is predictive of severe immune-related adverse events (irSAE) in the patient, the MRS determined based upon

$$MRS = - A \times CT\_GLN - B \times CT\_GS - C \times CT\_ZP + D \times KLD\_SZLGE - E \times KLD\_SRLGE + F ,$$

where CT_GLN is a grey-level nonuniformity determined from a grey level size zone matrix (GLSZM) indicating a number of groups of connected voxels with a common discretised grey level value and size, CT_GS is a means genometric symmetry determined from a texture spectrum matrix utilizing the CT features, CT_ZP is a zone percentage determined from the GLSZM utilizing the CT features, KLD_SZLGE is a small zone low gray level emphasis determined from the GLSZM utilizing KLD fusion images, and KLD_SRLGE is a short run low gray level emphasis determined from a grey level run length matrix (GLRLM) utilizing the KLD fusion images, and where A, B, C, D, E and F are constants with A in a range from about 0.74 to about 0.78, B in a range from about 0.75 to about 0.79, C in a range from about 0.59 to about 0.63, D in a range from about 1.29 to about 1.33, E in a range from about 0.37 to about 0.41, and F in a range from about 0.93 to about 0.97.

In some embodiments the MRS is determined based upon

$$MRS = - 0.76 \times CT\_GLN - 0.77 \times CT\_GS - 0.61 \times CT\_ZP + 1.31 \times KLD\_SZLGE - 0.39 \times KLD\_SRLGE + 0.95 .$$

In some embodiments the CT_GLN is determined by

$$CT\_GLN = \frac{1}{{\sum }_{i = 1}^{{N}_{g}} {\sum }_{j = 1}^{{N}_{z}} {S}_{ij}} {\sum }_{j = 1}^{{N}_{z}} {( {S}_{ij} )}^{2}$$

where sᵢⱼ=s(i,j) is number of zones with discretised grey level i and size j, N_{g} is a number of discretised grey levels, and N_{z} is a maximum zone size of a group of connected voxels.

In some embodiments the CT_GS is determined by

$$CT\_GS = ( 1 - \frac{1}{3} {\sum }_{j = 1}^{3} ( {\sum }_{i - 0}^{728} \vert {T}_{j} ( i ) - {T}_{j + 3} ( i ) \vert / {\sum }_{i - 0}^{728} 2 {T}_{j} ( i ) ) ) \times 100 \%$$

where Tⱼ is the texture spectrum matrix.

5. The method of claim 1, wherein the KLD_SZLGE is determined by

$$KLD\_SZLGE = \frac{1}{{\sum }_{i = 1}^{{N}_{g}} {\sum }_{j = 1}^{{N}_{z}} {S}_{ij}} {\sum }_{i = 1}^{{N}_{g}} {\sum }_{j = 1}^{{N}_{z}} \frac{{S}_{ij}}{{i}^{2} {j}^{2}}$$

where sᵢⱼ=s(i,j) is number of zones with discretised grey level i and size j, N_{g} is a number of discretised grey levels, and N_{z} is a maximum zone size of a group of connected voxels.

In some embodiments, the KLD_SRLGE is determined by

$$KLD\_SRLGE = \frac{1}{{\sum }_{i = 1}^{{N}_{g}} {\sum }_{j = 1}^{{N}_{r}} {r}_{ij}} {\sum }_{i = 1}^{{N}_{g}} {\sum }_{j = 1}^{{N}_{r}} \frac{{r}_{ij}}{{i}^{2} {j}^{2}}$$

where rᵢⱼ=r(i,j) is a number of occurrences where a discretized grey level i appears in j consecutive neighboring voxels or pixels, N_{g} is a number of discretised grey levels, and Nᵣ is a maximal possible run length along a specific direction.

In some embodiments the KLD images are constructed by fusing normalized PET and CT pixel-wise image data, I_{PET norm} and I_{CT norm} respectively, as given by

$${I}_{FUSE} = {I}_{PETnorm} + α {I}_{CTnorm} ,$$

$$with$$

$$α = {arg min}_{α ∈ [ 0.4 , 1 ]} ( {\sum }_{i = 0}^{L} {p}_{PET} ( i ) {log}_{2} \vert \frac{{p}_{PET} ( i )}{{p}_{FUSE} ( i )} \vert + {\sum }_{i = 0}^{L} {p}_{CT} ( i ) {log}_{2} \vert \frac{{p}_{CT} ( i )}{{p}_{FUSE} ( i )} \vert ) ,$$

where P_{PET}, P_{CT} and P_{FUSE} are normalized histograms of the PET, CT, and KLD images, respectively, and L is a number of bins.

The details of one or more embodiments of the invention are set forth in the accompanying drawings and the description below. Other features, objects, and advantages of the invention will be apparent from the description and drawings, and from the claims.

### BRIEF DESCRIPTION OF FIGURES

FIG. 1 is a diagram of study participant enrollment. AE=adverse event, G3=grade 3, irSAE=severe immune-related AE, NSCLC=non-small cell lung cancer.

FIG. 2 shows radiomics score (RS) (panels A-C) and radiomics nomogram (panels D-F) predicted the probability for every patient in the training cohort, test cohort, and prospective test cohort. The irSAE status is marked with different colors. irAE=immune-related adverse event, irSAE=severe irAE.

FIG. 3A shows receiver operating characteristic (ROC) curves for the radiomics score (RS) in the augmented training, training, test, and prospective test cohorts. FIGS. 3B and 3C show ROC curves for the RS in patients who received anti-programmed cell death ligand 1 (PD-L1) immunotherapy and anti-programmed cell death protein 1 (PD-1) immunotherapy. FIG. 3D shows ROC curves for the radiomics nomogram in the augmented training, training, test, and prospective test cohorts. FIGS. 3E and 3F shows ROC curves for the radiomics nomogram in patients who received anti-PD-L1 immunotherapy and anti-PD-1 immunotherapy. Given that no severe immune-related adverse events occurred in the prospective test cohorts who received anti-PD-L1 immunotherapy, no ROC curves for the prospective test cohorts are given in FIGS. 3B and 3D. ACC=accuracy, AUC=area under the ROC curve.

FIGS. 4A to 4D show radiomics nomogram to estimate the risk of severe immune-related adverse effect (irSAE) and performance evaluation of its results. FIG. 4A shows detailed radiomics nomogram constructed with the radiomics score (RS), treatment type, and dosage. For example, in a patient with RS of 0.6 who received anti-programmed death ligand 1 (PD[L]1) plus chemotherapy (Chemo) with a dosage level of 2, the total points would be 70 (RS of 0.6=55 points, anti-PD[L]1 plus Chemo=10 points, dosage level of 2=5 points), which corresponds to a risk of developing irSAE of 0.9. CTLA-4=cytotoxic T-lymphocyte-associated protein 4. FIG. 4B shows assessment of the model calibration in the retrospective and prospective cohorts. FIG. 4C is a scatterplot of the nomogram-predicted irSAE probability in individuals. FIG. 4D shows decision curves for the RS, the complete radiomics nomogram (RS+clinical), and the clinical-only nomogram.

FIGS. 5A and 5B show Kaplan-Meier survival curves for progression-free survival according to the radiomics nomogram-predicted probability in the retrospective cohorts (FIG. 5A) and the prospective cohort (FIG. 5B). GH=high risk, GL=low risk.

FIG. 6 illustrates a radiomics method. The workflow includes image selection (only images with slice thickness ≤5 mm no artifacts, and the tumor in PET images has FDG uptake were included), registration and automatic delineation, imaging preprocessing and feature extraction, feature selection, model training and model validation.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, biology, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

WO 2021/118918 and WO 2021/030784 are incorporated by reference for methods for generating radiomic signatures in lung cancer. The disclosed methods expand on these methods to predict severe immune-related adverse events in patients with lung cancer.

¹⁸F-FDG PET/CT images

Positron emission tomography with 2-deoxy-2-[fluorine-18]fluoro-D-glucose integrated with computed tomography (18F-FDG PET/CT) has emerged as a powerful imaging tool for the detection of various cancers. The combined acquisition of PET and CT has synergistic advantages over PET or CT alone and minimizes their individual limitations.

A PET/CT scanner is an integrated device containing both a CT scanner and a PET scanner with a single patient table and therefore capable of obtaining a CT scan, a PET scan, or both. If a patient does not move between the scans, the reconstructed PET and CT images will be spatially registered. PET/CT registration is the process of aligning PET and CT images for the purposes of combined image display (fusion) and image analysis. PET/CT fusion is the combined display of registered PET and CT image sets. Superimposed data typically are displayed with the PET data color coded to the CT data in gray scale. PET/CT acquisitions can include the whole body, an extended portion of the body, or a limited portion of the body.

With PET/CT, the radiation dose to the patient is the combination of the radiation dose from the PET radiopharmaceutical and the radiation dose from the CT portion of the study. Radiation dose in diagnostic CT has attracted considerable attention in recent years, in particular for pediatric examinations. It can be very misleading to state a “representative” dose for a CT scan because of the wide diversity of applications, protocols, and CT systems. This caveat also applies to the CT component of a PET/CT study. For example, a body scan may include various portions of the body and may use protocols aimed to reduce the radiation dose to the patient or aimed to optimize the CT scan for diagnostic purposes. The effective dose could range from approximately 5 to 80 mSv (0.5-8.0 rems) for these options. It is therefore advisable to estimate the CT dose specific to the CT system and protocol being used. Pediatric and adolescent patients should have their CT examinations performed at milliampere-seconds settings appropriate for patient size, regardless of the CT protocol used, because radiation dose to the patient increases significantly as the diameter of the patient decreases.

The CT component of a PET/CT examination can be performed either for AC/AL or as an optimized diagnostic CT scan. An AC/AL CT scan has not necessarily been optimized as a diagnostic CT examination, whereas for a diagnostic CT scan, such optimization has been attempted. In some circumstances, both an initial CT acquisition for AC/AL (before the PET data acquisition) and diagnostic CT (after the PET data acquisition) are performed. If the CT scan is obtained for AC/AL, a low milliampere-seconds setting is recommended to decrease the radiation dose to the patient. For an optimized diagnostic CT scan, standard CT milliampere-seconds settings are recommended to optimize the spatial resolution of the CT scan. Tube current modulation may be used to minimize radiation dose to the patient. In some cases, intravenous or oral contrast material may be used. A separate CT acquisition may be necessary to produce an optimized diagnostic CT scan that is requested for a particular region of the body. For many indications, the examination is performed with intravenous contrast material and appropriate injection techniques. High intravascular concentrations of intravenous contrast material may cause an attenuation correction artifact on the PET image, but the impact usually is modest. This artifact is minimized on scanners by use of appropriate correction factors. For either a CT scan done for AC/AL or an optimized diagnostic CT scan of the abdomen or pelvis, an intraluminal gastrointestinal noncaloric contrast agent may be administered to provide adequate visualization of the gastrointestinal tract unless it is medically contraindicated or unnecessary for the clinical indication. This agent may be a positive contrast agent (such as dilute barium), an oral iodinated contrast agent, or a negative contrast agent (such as water). Collections of highly concentrated barium or iodinated contrast agents can result in an attenuation correction artifact that leads to a significant overestimation of the regional 18F-FDG concentration; other, dilute positive and negative oral contrast agents cause less overestimation and do not affect PET image quality. With regard to the breathing protocol for CT transmission scanning, in PET/CT, the position of the diaphragm on the PET emission images should match as closely as possible that on the CT transmission images. Although a diagnostic CT scan of the chest typically is acquired during end-inspiration breath holding, this technique is not optimal for PET/CT because it may result in substantial respiratory motion misregistration on PET and CT images. Some facilities perform CT transmission scans during breath holding at midinspiration volume, and others prefer that the patient continue shallow breathing during the CT acquisition. Respiratory motion results in inaccurate localization of lesions at the base and periphery of the lungs, in the dome of the liver, or near any lung-soft tissue interface and may result in spurious standardized uptake value (SUV) determinations. Motion correction or respiratory gating is recommended when available.

For PET emission imaging, the radiopharmaceutical should be injected at a site contralateral to the site of concern. Emission images should be obtained at least 45 min after radiopharmaceutical injection. The optimal ¹⁸F-FDG distribution phase is controversial. Many facilities start the acquisition of the images at 60 or 90 min after ¹⁸F-FDG administration. Some facilities obtain a second set of images to assess the change in uptake over time. The ¹⁸F-FDG uptake time should be constant whenever possible and certainly when 2 studies are being compared by use of semiquantitative parameters, especially the SUV. The emission image acquisition time varies from 2 to 5 min or longer per bed position for body imaging and is based on the administered activity, patient body weight, and sensitivity of the PET scanner (as determined largely by detector composition and acquisition method). Typically, for imaging skull to midthigh, the total acquisition time ranges from 15 to 45 min. The imaging time typically is prolonged for the acquisition of brain images or for images of a limited region of interest. Semiquantitative estimation of tumor glucose metabolism by use of the SUV is based on relative lesion radioactivity measured on images corrected for attenuation and normalized for the injected dose and body weight, lean body mass, or body surface area. This measurement is obtained on a static emission image typically acquired more than 45 min after injection. The accuracy of SUV measurements depends on the accuracy of the calibration of the PET scanner, among other factors. The reproducibility of SUV measurements depends on the reproducibility of clinical protocols, for example, dose infiltration, time of imaging after ¹⁸F-FDG administration, type of reconstruction algorithms, type of attenuation maps, size of the region of interest, changes in uptake by organs other than the tumor, and methods of analysis (e.g., maximum and mean). Semiquantitative estimation of tumor metabolism can be based on the ratio of ¹⁸F-FDG uptake in a lesion to ¹⁸F-FDG uptake in internal reference regions, such as the blood pool, mediastinum, liver, and cerebellum.

PET emission data consist of the number of events along lines of response between detector pairs. The emission data must be corrected for detector efficiency (normalization), system dead time, random coincidences, scatter, attenuation, and sampling nonuniformity. Some of these corrections (e.g., attenuation) can be incorporated directly into the reconstruction process. Scanners with retractable septa can acquire data in both 2-dimensional (2D) and 3-dimensional (3D) modes, whereas scanners without septa acquire data in the 3D mode only. Datasets acquired in the 3D mode either can be rebinned into 2D data and reconstructed with a 2D algorithm or can be reconstructed with a fully 3D algorithm. Iterative reconstruction approaches are now widely available for clinical applications in both 2D and 3D modes, largely replacing the direct, filtered backprojection methods used previously. For a given algorithm, the appropriate reconstruction parameters will depend on the acquisition mode, the type of scanner, and the imaging task. It is considered good practice to archive reconstructions both with and without attenuation correction to resolve issues arising from potential artifacts generated by the CT-based attenuation correction procedure. The reconstructed image volume can be displayed in transaxial, coronal, and sagittal planes and as a rotating maximum-intensity-projection image.

CT sinograms are reconstructed by filtered backprojection at full field of view for the data used for attenuation correction of the PET emission data and separately for CT interpretation with appropriate zoom, slice thickness and overlap, and reconstruction algorithms for the particular region of the body scanned. The filtered backprojection can be either 2D after appropriate portions of the spiral CT data are collected into axial or tilted planes or fully 3D. In addition to the reconstruction kernel that adjusts in-plane features, such as spatial resolution and noise texture, longitudinal filtration (along the z-axis) is used to modify the z-resolution and the slice sensitivity profiles. In addition, there are techniques for emphasizing certain image features, for example, bone, lung, or head algorithms. For attenuation correction, only the standard kernels are used. Because CT volumes today are nearly isotropic, reslicing in coronal, sagittal, or even curved displays often is preferred. Advanced display techniques, such as volume rendering and maximum- or minimum-intensity projections applied to the complete volume or to thick, arbitrarily oriented sections, often are used. Organ- and task-specific automatic or semiautomatic segmentation algorithms and special evaluation algorithms also are in routine use.

With an integrated PET/CT system, typically the software packages provide registered and aligned CT images, ¹⁸F-FDG PET images, and fusion images in the axial, coronal, and sagittal planes as well as maximum-intensity-projection images for review in the 3D cine mode. ¹⁸F-FDG PET images with and without attenuation correction should be available for review.

### Image Features

PET and CT images can be analyzed for 3D image features, including textural, statistical, morphological, and diagnostic features, which have been developed and validated by the Imaging Biomarker Standardization Initiative, IBSI, and are described in Zwanenburg et al (Radiology 2020; 295:328-338) and Gillies et al (Radiology 2016; 278(2):563-577, which are incorporated by reference in their enteritis for the teaching of these methods.

Fusion images can then be constructed based on Kullback-Leibler Divergence (KLD) criteria to retain most of the initial information of both PET images and CT images, referred to herein as KLD images, which can then be evaluated for KLD features. For example, the fusion images can be calculated through the equation:

$${I}_{FUSE} = {I}_{PETnorm} + α {I}_{CTnorm} , \qquad ( 0.1 )$$

where I_{PET norm} and I_{CT norm} are the normalized PET and CT pixel-wise image data with the following scheme to keep the negative values in CT images:

$${I}_{Xnorm} = \frac{{I}_{X}}{max ( {I}_{X} )} ( X represents PET or CT ) , \qquad ( 0.2 )$$

a was selected based on the following improved minimum KLD criterion:

$$α = {arg min}_{α ∈ [ 0.4 , 1 ]} ( {\sum }_{i = 0}^{L} {p}_{PET} ( i ) {log}_{2} \vert \frac{{p}_{PET} ( i )}{{p}_{FUSE} ( i )} \vert + {\sum }_{i = 0}^{L} {p}_{CT} ( i ) {log}_{2} \vert \frac{{p}_{CT} ( i )}{{p}_{FUSE} ( i )} \vert ) , \qquad ( 0.3 )$$

where P_{PET}, P_{CT} and P_{FUSE} are the normalized histograms of the PET, CT, and fusion images, respectively. L is the number of bins.

Texture features, as described in Zwanenburg et al. (Radiology 2020 295:328-338) and Gillies et al (Radiology 2016; 278(2):563-577), can then be calculated from the above KLD fusion images, referred to herein as KLD features. The use of KLD to fuse images from different modalities (i.e. PET and CT) has not been described previously.

### Modified Radiomics Score

The least absolute shrinkage and selection operator (LASSO) method can be used to select the most informative radiomic features from the selected robust and nonredundant features. The penalty parameter of LASSO was selected using 10-fold cross validation via minimum mean cross-validated error. Based on these selected features, a radiomics score (RS) can be computed for each patient through a linear combination weighted by the corresponding LASSO regression coefficients. Here, a modified RS (MRS) can be calculated using the following:

$$MRS = - A \times CT\_GLN - B \times CT\_GS - C \times CT\_ZP + D \times KLD\_SZLGE - E \times KLD\_SRLGE + F ,$$

where A can be in a range from about 0.74 to about 0.78, B can be in a range from about 0.75 to about 0.79, C can be in a range from about 0.59 to about 0.63, D can be in a range from about 1.29 to about 1.33, E can be in a range from about 0.37 to about 0.41, and F can be in a range from about 0.93 to about 0.97. In one example,

$$MRS = - 0.76 \times CT\_GLN - 0.77 \times CT\_GS - 0.61 \times CT\_ZP + 1.31 \times KLD\_SZLGE - 0.39 \times KLD\_SRLGE + 0.95$$

The grey level size zone matrix (GLSZM) counts the number of groups of connected voxels with a specific discretised grey level value and size. Voxels are connected if the neighbouring voxel has the same discretised grey level value. Whether a voxel classis as a neighbour depends on its connectedness. In the 3 dimensional approach to texture analysis, consider 26-connectedness which indicates that a connection exists if any of the 26 neighbouring voxels shares the grey level of the centre voxel.

CT_GLN means grey-level nonuniformity calculated from GLSZM utilizing CT features as the following:

$$CT\_GLN = \frac{1}{{\sum }_{i = 1}^{{N}_{g}} {\sum }_{{j = 1}^{}}^{{N}_{z}} {s}_{ij}} {\sum }_{{j = 1}^{}}^{{N}_{z}} {( {s}_{ij} )}^{2} .$$

CT_ZP means zone percentage calculated from GLSZM utilizing CT features with the following:

$$CT\_GLN = \frac{1}{{N}_{v}} {\sum }_{i = 1}^{{N}_{g}} {\sum }_{j = 1}^{{N}_{z}} {s}_{ij} .$$

KLD_SZLGE means small zone low gray level emphasis calculated from GLSZM utilizing KLD images with the following:

$$KLD\_SZLGE = \frac{1}{{\sum }_{i = 1}^{{N}_{g}} {\sum }_{{j = 1}^{}}^{{N}_{z}} {s}_{ij}} {\sum }_{i = 1}^{{N}_{g}} {\sum }_{j = 1}^{{N}_{z}} \frac{{s}_{ij}}{{i}^{2} {j}^{2}}$$

sᵢⱼ=s(i,j) is number of zones with discretised grey level i and size j. Nᵥ is the number of voxels. N_{g} is the number of discretised grey levels present in the volume. N_{z} is the maximum zone size of a group. For example, N_{g} was set as 128 in this work.

KLD_SRLGE means short run low gray level emphasis calculated from grey level run length matrix (GLRLM) utilizing KLD images with the following:

$$KLD\_SRLGE = \frac{1}{{\sum }_{i = 1}^{{N}_{g}} {\sum }_{{j = 1}^{}}^{{N}_{r}} {r}_{ij}} {\sum }_{i = 1}^{{N}_{g}} {\sum }_{j = 1}^{{N}_{r}} \frac{{r}_{ij}}{{i}^{2} {j}^{2}}$$

rᵢⱼ=r(i,j) is the number of occurrences where discretized grey level i appears in j consecutive neighboring voxels or pixels. N_{g} is the number of discretized grey levels, Nᵣ is the maximal possible run length along the specific direction. The final value is calculated as the average value of 13 unique direction vectors within a neighborhood volume for distance 1, i.e. (0; 0; 1), (0; 1; 0), (1; 0; 0), (0; 1; 1), (0; 1; 1), (1; 0; 1), (1; 0; 1), (1; 1; 0), (1; 1; 0), (1; 1; 1), (1; 1; 1), (1; 1; 1) and (1; 1; 1).

CT_GS means genometric symmetry calculated from texture spectrum matrix utilizing CT features with the following:

$$CT\_GS = ( 1 - \frac{1}{3} {\sum }_{j = 1}^{3} ( {\sum }_{i - 0}^{728} \vert {T}_{j} ( i ) - {T}_{j + 3} ( i ) \vert / {\sum }_{i - 0}^{728} 2 {T}_{j} ( i ) ) ) \times 1 \; 00 \% .$$

The KLD fusion images were constructed based on improved minimum Kullback-Leibler Divergence (KLD) criteria to retain most of the initial information of both PET images and CT images, named KLD images hereafter. The fusion images were calculated through the equation:

$${I}_{FUSE} = {I}_{PETnorm} + α {I}_{CTnorm} ,$$

where I_{PET norm} and I_{CT norm} are the normalized PET and CT pixel-wise image data with the following scheme to keep the negative values in CT images:

$${I}_{Xnorm} = \frac{{I}_{X}}{max ( {I}_{X} )} ( X represents PET or CT ) ,$$

α was selected as 0.6 in this work based on the following improved minimum KLD criterion:

$$α = {arg min}_{α ⊂ [ 0.4 , 1 ]} ( {\sum }_{i = 0}^{L} {p}_{PET} ( i ) {log}_{2} \vert \frac{{p}_{PET} ( i )}{{p}_{FUSE} ( i )} \vert + {\sum }_{i = 0}^{L} {p}_{CT} ( i ) {log}_{2} \vert \frac{{p}_{CT} ( i )}{{p}_{FUSE} ( i )} \vert ) ,$$

where P_{PET}, P_{CT} and P_{FUSE} are the normalized histograms of the PET, CT, and fusion images, respectively. L is the number of bins and was set to 128 in this study. The MRS can be used to predict the response to checkpoint blockade and identifying patients at risk for irSAEs.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”. A number of embodiments of the invention have been described. Nevertheless, it will be understood that various modifications may be made without departing from the spirit and scope of the invention. Accordingly, other embodiments are within the scope of the following claims.

### EXAMPLES

### Example 1: Radiomics of 18FDG PET/CT Images Predict Immune-Related Severe Adverse Events in NSCLC Patients

### Patients and Methods

### Patients

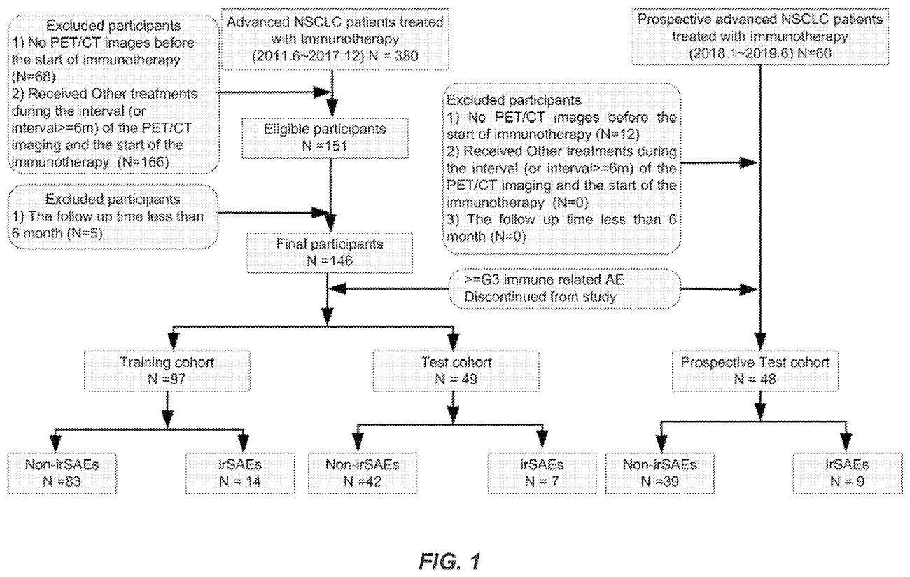

This retrospective study was approved by the Institutional Review Board at the X University, and the need for informed consent was waived to assure anonymity. Inclusion criteria included patients with histologically confirmed advanced stage (IIIB and IV) NSCLC who were treated with immune checkpoint blockade between June 2011 and December 2017 at the Institute A. In order to enroll more data for analysis, and compare the difference of different immune checkpoint blockade in generating irSAEs, patients from different clinical tries treated with four main different treatments were enrolled: (1) Single anti-PD-(L)1 agent; (2) Combined anti-PD-(L)1 agent and anti-CTLA-4 agent; (3) Combined anti-PD-(L)1 agent and Gefitinib; (4) Combined anti-PD-(L)1 agent and chemotherapeutic agent. Generally, the onset of the toxicity is in the first 4 months in 85% of the patients (Kumar et al. Front Pharmacol 2017 8:49), so the minimum follow-up period in our study was 6 months after immunotherapy. Additionally, all the patients had a PET/CT scan within 6 months of therapy initiation and had no intervening therapies. The detailed exclusion criteria diagram was shown in FIG. 1. Based on these inclusion criteria, we identified 146 patients who were randomly divided into a training cohort (97 patients) and independent test cohort (49 patients) on the only condition that the two cohorts have similar distributions of FDG uptake, determined as SUVmax, to ensure that the two cohorts had similar distributions of metabolic characteristics. Furthermore, 48 patients were enrolled in a prospective study with the same inclusion and exclusion criteria at the Institute A since January 2018 to June 2019, and were used for the prospective validation.

Clinical characteristics were obtained from the medical records including age at diagnosis, sex, body mass index (BMI), historical treatments, smoking status, history of COPD (chronic obstructive pulmonary disease), ECOG, and sites of distant metastasis (M). Patients with irSAEs (with Grade 3 or worse irAEs, and was discontinued the immune checkpoints blockade treatment permanently) were taken as cases for our study, and patients without irSAEs were randomly selected as control patients. Progression free survival (PFS) was chosen as the end point of the study, which were defined as the time from the start date of immunotherapy to progression (defined according to Response Evaluation Criteria in Solid Tumors (RECIST1.1)), and patients free of progression or lost to follow-up were censored at the time of last confirmed contact.

### PET/CT Imaging

All PET images were converted into SUV units by normalizing the activity concentration to the dosage of ¹⁸F-FDG injected and the patient body weight after decay correction.

### Radiomic Feature Extraction

The primary lung tumors of PET and CT images were segmented with an improved level-set method based on the gradient fields (Mu et al. IEEE Trans Biomed Eng 2015 62(10):2465-2479) semi-automatically, which were rigidly registered firstly by maximizing the Dice Similarity Coefficients on the condition that the maximal axial cross sections of the nodules were aligned. After over reading and correcting by a chest radiologist—(16-year experience) who were blinded to the data classes, 1092 radiomic features were extracted from these segmented tumors.

### Statistical Analysis

Student's t test and Fisher's exact test were used to compare training and test cohorts for continuous variables and categorical variables, respectively. For PFS comparison, Kaplan-Meier analysis and log-rank test was used. ANOVA analysis was performed to compare the distribution of the radiomics signatures among the different reconstruction parameters. P-value less than 0.05 was regarded as significant, and statistical analyses were conducted with R (version 3.5.1) and MATLAB (R2016b).

### Feature Selection and Radiomic Signature Building

Since there is a low-incidence of irSAEs, to correct for imbalance between the two classes (irSAEs vs. no irAEs or with irAEs but no need to discontinuation), data augmentation was used to balance and enlarge the training cohort. The robust features were first selected based on resampling classification ability, which were further reduced by Pearson grouping to reduce redundancy. Subsequently, the least absolute shrinkage and selection operator (LASSO) method was used to select the useful features from the selected robust and non-redundant features. The penalty parameter of LASSO was selected using 10-fold cross validation via minimum mean cross-validated error. Based on these selected features, we could compute radiomics signature for each patient through a linear combination weighted by the corresponding LASSO regression coefficients, named as MRS.

### Development of the Individualized Radiomics Nomogram Model

Univariable logistical regression analysis was conducted with MRS, the clinical factors, along with the clinical common used metrics including SUVmax, MTV (metabolic tumor volume) (Crivellaro et al. Gynecol Oncol 2012 127(1):131-135) and volume (from CT images) on the training cohort, and only factors having statistically significant odds ratio (OR) were used for developing the irSAEs prediction model with multivariable logistical regression analysis. Due to the imbalance of the different treatment method, weighted multivariable logistical regression analysis was used, and the weight for each patient was determined by the product of the number of patients who received another two treatments. Backward step-wise selection was applied using the likelihood ratio test with Akaike information criterion was used as the stopping rule. Based on this analysis, a radiomics nomogram model for irSAEs identification was obtained for clinical use.

Qualitatively, calibration curves were plotted to determine the agreement between the estimated probability and the actual irSAEs rate based on the retrospective and the prospective cohorts respectively. Additionally, to compare the clinical usefulness of the different models, a decision curve analysis was performed by quantifying the new benefits at different threshold probabilities (Fitzgerald. JAMA 2015 313 (4): 409-410).

Quantitatively, the goodness-of-fit of the models were evaluated with Akaike Information Criterion (AIC) and the Hosmer-Lemeshow (HL) test, an insignificant test statistic implied that the model was well calibrated. The Area Under the curve of the Receiver Operating Characteristic (AUC) and classification accuracies (ACC) were calculated to evaluate the discrimination performances of different models in the augmented training, training, test and prospective test cohorts. Furthermore, positive likelihood ratio (+LR) and negative likelihood ratio (−LR), were also calculated for the diagnosis evaluation. To demonstrate the significantly incremental value of the MRS with the clinical characteristics, total net reclassification improvement (NRI) was calculated.

### Results

### Clinical Characteristics

Among the 146 patients, there are 88 men and 58 women with the overall mean age of 65.72(±12.88) and the median PFS of 6.85 months. 5 different autoimmune diseases were found in this cohort, including 6 colitis/diarrhea, 8 pneumonitis, 2 Guillain-Barre Syndrome, 3 hepatitis, 1 myalgia and 1 rash patients. The median (range) interval time between the start of immunotherapy and severe autoimmune disease occurrence was 3.55 month (0.47˜24.17 month). For the 48 retrospective patients including 23 men and 25 women with the mean age of 66.44 (+9.77) and median PFS of 6.78 months, 3 different autoimmune diseases (4 colitis/diarrhea, 4 pneumonitis, and 1 hepatitis) were found within 1.43 month (0.93˜14.63 month) since the start of immunotherapy. The demographic characteristics are shown in Table 1.

There were no significant differences between the two cohorts for all the clinical characteristics or follow-up data, and the two cohorts had identical distributions of SUVmax, and statistically insignificant difference in their PFS (p=0.38).

### Feature Selection and Radiomics Signature Building

According to each feature's resampling classification ability, 12 PET features, 41 CT features, and 12 KLD features were selected for their robust prediction ability. After Pearson grouping, 21 features with the largest resampling classification ability in each group were feed into the LASSO method. From these analyses, 5 features were selected to construct the MRS, which were incorporated into the following calculation formulas (detailed description was shown in Appendix E1 section 10).

$$R a d i {o}_{Mutual} = - 0.76 \times CT\_GLN - 0.77 \times CT\_GS - 0.61 \times CT\_ZP + 1.31 \times KLD\_SZLGE - 0.39 \times KLD\_SRLGE + 0.95 \qquad ( 1.1 )$$

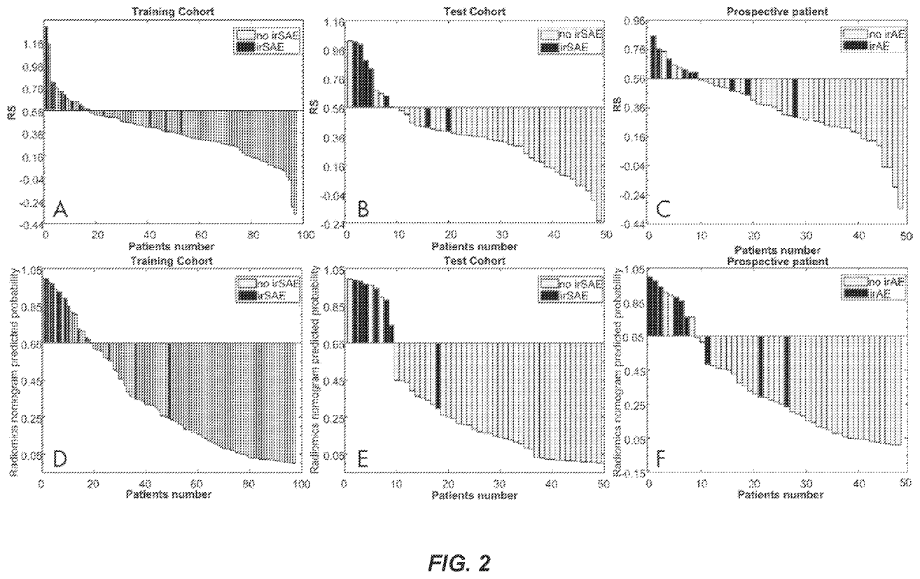

The distributions of the MRS and the irSAEs status for each patient in the training, test and prospective cohorts are shown in FIG. 2(A1˜A3).

To perform ANOVA analysis, we regarded the scanners that had less than 5 cases as one type, obtaining 8 different types all together. The p-value of ANOVA analysis between groups for MRS was 0.42. And the p value of pairwise post hoc LSD test is in the ranges of 0.80 to 1, indicating that the MRS were stable among different scanners and reconstruction parameters, which are also shown by the box blot. The prospective study also showed the stability of MRS with the p value of 0.227 with ANOVA analysis. Additionally, Student's test shows that there was no significant difference between retrospective and prospective cohorts on the same scanners and reconstruction parameter (p>0.05, details were shown in FIG. S2B).

### Diagnostic Validation of the Radiomics Signature

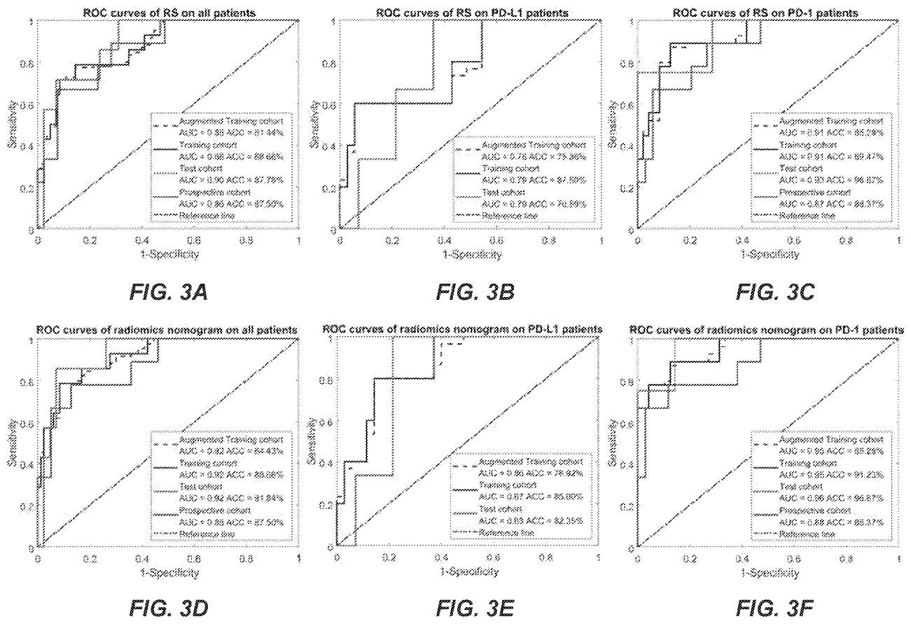

There was a significant difference in MRS between irSAEs and non-irSAEs patients in the training cohort (p<0.001), which was validated in test cohort (p<0.001) and prospective cohort (p<0.001). This signature could yield an AUC of 0.879 (95% Cl: 0.805-0.952), 0.898 (95% Cl: 0.815-0.980) and 0.860 (0.763-0.957) in the training and test cohorts respectively. Detailed information of radiomics signature performance is shown in Table 2, and the corresponding ROC curves are shown in FIG. 3(A1).

Development of the Individualized Radiomics Nomogram Model for irSAEs Prediction

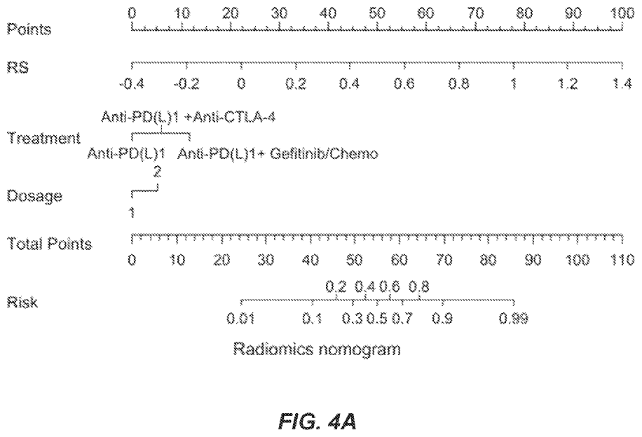

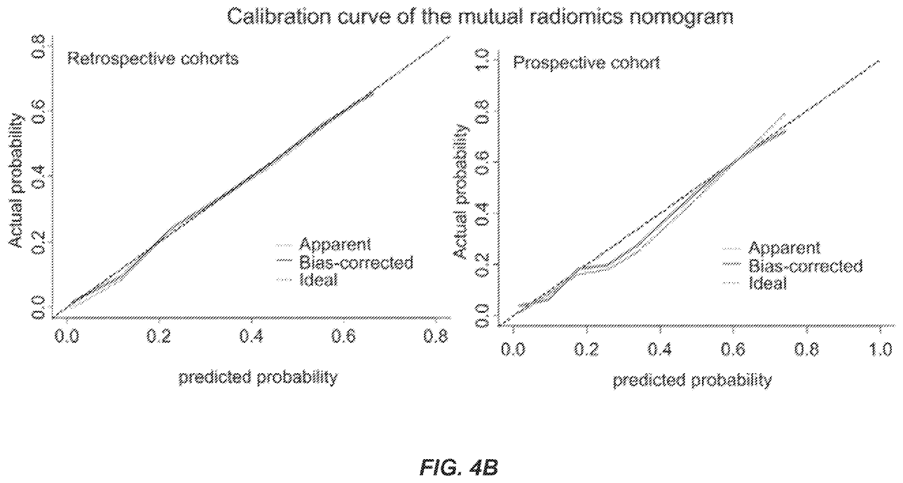

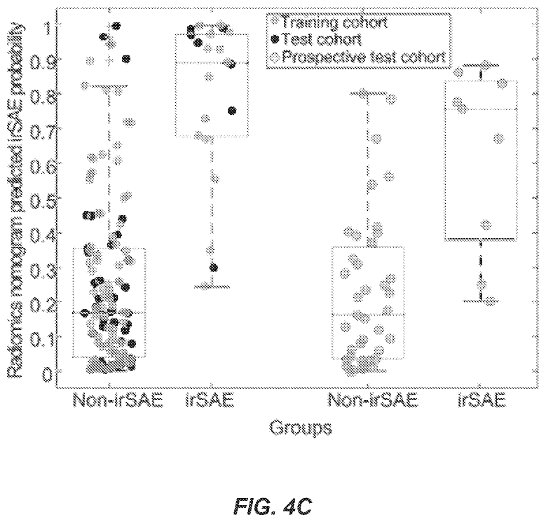

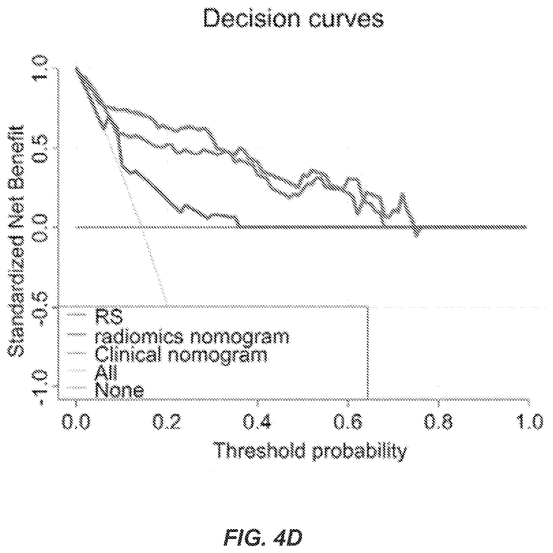

Univariable logistical regression analysis identified the MRS, immunotherapy treatment type, and dosage as strong predictors for irSAEs (p<0.001, p=0.032 and p=0.029, respectively, Table 4). The following weighted multivariate logistic regression analysis identified MRS, immunotherapy treatment type, and dose as independent risk factors (MRS: p<0.001, HR: 4.20×10³, 95% Cl: 176.37-9.98×10⁴; immunotherapy treatment type: p=0.005, HR: 2.40, 95% Cl: 1.30-4.43; dose: p=0.074, HR: 2.15, 95% Cl: 0.93-4.97), which was presented as radiomics nomogram shown in FIG. 4(A). The distributions of the nomogram predicted probability and the irSAEs status for each patient in the training, test and prospective test cohorts are shown in FIG. 2(B1˜B3). The calibration curves (FIG. 4(B)) of the radiomics nomogram predicting the irSAEs probability showed good agreement in the cohort and the whole real cohort. The Hosmer-Lemeshow test showed a good logistic fit on training (p=0.79), test (p=0.83), and prospective (p=0.84) cohorts. This nomogram could yield an AUC of 0.917 (95% Cl: 0.864-0.976),0.925 (95% Cl: 0.859-0.991) and 0.877 (0.782-0.973) in the training, test and prospective test cohorts respectively, which were shown in Table 2 in detail. The +LR (12.00) and the −LR (0.15) in test dataset shows the radiomics nomogram had a large effect on increasing the probability of irSAEs presence, and a moderate effect on decreasing the probability of irSAEs presence. The corresponding ROC curves are shown in FIG. 3(B1).

When compared to MRS, the inclusion of the treatment types and dose yielded a total net reclassification improvement of 0.42 (95% Cl: 0.15-0.70, p=0.0027) in the training cohort and 0.62 (95% Cl: 0.020-1.22, p=0.043) in the test cohort, which showed significantly improved classification accuracy for irSAEs prediction. When compared to clinical nomogram (immunotherapy treatment type: p<0.001, HR: 2.55, 95% Cl: 1.51-4.29; dose: p<0.001, HR: 3.36, 95% Cl: 1.72-6.55), the inclusion of mutual radiomics score yielded a total net reclassification improvement of 1.07 (95% Cl: 0.81-1.32, p<0.001) in the training cohort, 1.43 (95% Cl: 0.87-1.99, p<0.001) in the test cohort and 1.09 (95% Cl: 0.49-1.70,p<0.001) in the prospective cohorts, which also showed significantly improved classification accuracy for irSAEs prediction.

The decision curve analysis results (FIG. 4(D)) revealed the performance of the MRS, clinical nomogram model, and radiomics nomogram model in clinical application. All three models show advantages than either the scheme in which all patients are assumed to have irSAEs or the scheme in which no patients have irSAEs. When comparing the three models, the radiomics nomogram model had the highest overall net benefit across the majority of the range of reasonable threshold probabilities in both retrospective and prospective cohorts.

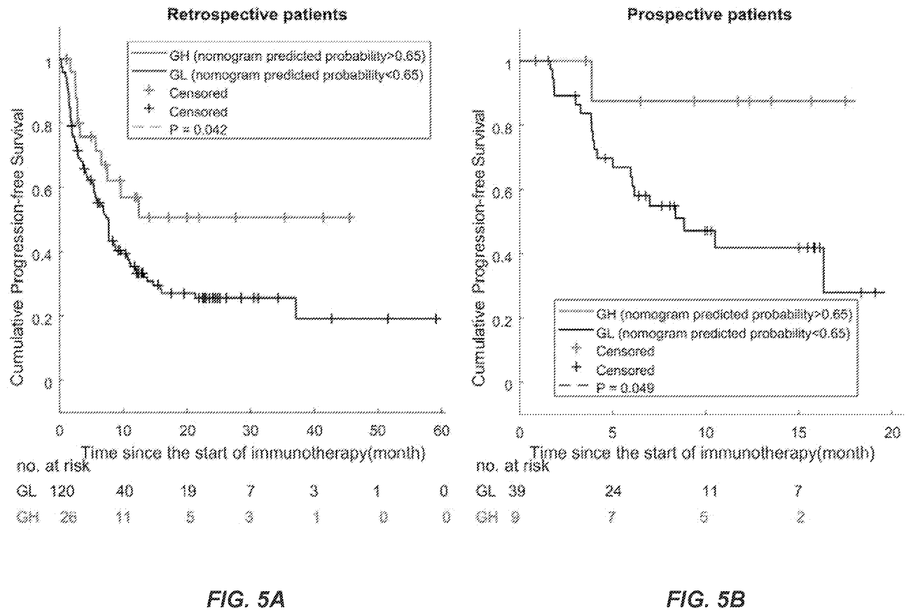

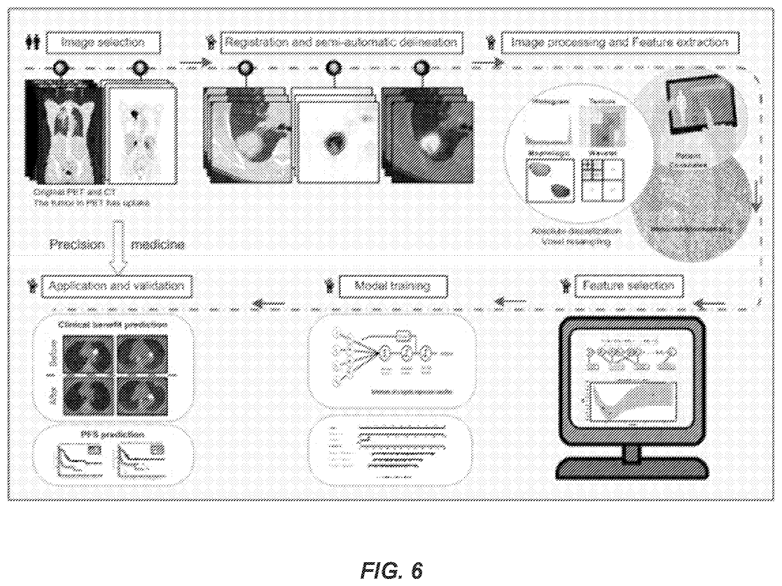

The retrospective patients were further clustered into high risk (GH) and low risk (LH) groups according to the cutoff point determined by the Youden Index of the augmented training cohort, and the median PFS of GH patients was 9.43 months, which was significantly longer than the LH patients with median PFS of 6.23 months (p=0.042, FIG. 5A). Further prospective patients stratification showed that the GH patients had a significantly longer median PFS of 11.47 months versus the 6.23 months of the LH patients (p=0.049, FIG. 5B).

### DISCUSSION

In this work, we found that high MRS, combined immunotherapy treatment, and high dosage were risk factors for irSAEs. A radiomics nomogram model that incorporated these risk factors was validated to predict on-set of irSAEs. The accurate prediction of this model in the prospective cohort further showed that this model could provide an effective tool to optimize patient management and treatment plan. Early intervention for the identified patients with high risk of irSAEs will help these patients obtain more benefit of immunotherapy.

Radiomics, an emerging and promising approach, provides a way to relate the PET/CT images to metastasis prediction (Wu et al. Radiology 2016 281(1):270-278; Vallières et al. Phys Med Biol 2015 60(14):5471) and prognosis estimation of new therapy (Carvalho et al. Radiother Oncol 2016 118:S20-S21; Kirienko et al. Eur J Nucl Med Mol Imag 2018 45(2):207-217) for NSCLC patients, and help us to connect the metabolic level information with the macroscopic level representation. Due to the fact that any organ system could be affected by the unbalancing immune system, the determination of the region of interest (ROI) can be challenging. Given numerous literature (Hassani et al. Am J Roentgenol 2019 212(3):497-504) showed the primary nodule could reflect most of the genetic and micro environment information, the radiomics analysis of the irSAEs was performed on the primary nodule.

When we looked into the informative components of MRS, the most important feature with highest weight is SZHGE from KLD images, meaning that patients with tumors consisting with many small, highly metabolic and attenuation-connected regions are more likely to have irSAEs. Additionally, smaller CT_ZP (meaning strongly linear ROI volumes), smaller CT_GS (meaning irregular shape) and smaller GLN were also related to the high risk of irSAEs. According to Saeed-vafa's study (Saeed-Vafa et al. bioRxiv 2017:190561), the more linear and irregularly shaped tumors, i.e. those that are growing around blood vessels, express less PD-L1, which means the irSAE may be associated with PD-L1 expression depending on further study with larger cohorts.

In order to evaluate the effect of the segmentation on the calculation of MRS, different segmented boundaries were obtained through automated dilation and shrinkage of the tumor boundaries by 1 voxel and 2 voxels on PET images and 3˜6 voxels (according to the ratio of PET axial resolution and CT axial resolution) on CT images, named dialation1, dailation2, shrinkage1, and shrinkage2. The mean MRSs and the relative standard deviations obtained over different boundaries were given together with the MRS calculated from the accurate segmentation on the prospective cohort. There was no significant difference between the MRS obtained with dialation1, shrinkage1, shrinkage2 boundaries and the MRS obtained with accurate segmentation boundaries (p=0.21, p=0.15 and p=0.14). The significant difference between dialation2 and accurate boundaries (p=0.022) may be due to the inclusion of pleura or other soft tissues. The AUCs of the MRS obtained with dialation1, shrinkage1, dialation2, shrinkage2 boundaries and the MRS obtained 0.852, 0.846, 0.821, and 0.806, which means the MRS is stable across small variation of segmentation boundaries.

Given the PET/CT scans acquired at different time point before the start of the immunotherapy, the temporal relationship between the PET/CT scan time and the output of the model was further investigated (FIG. S4). Based on the AUCs calculated with the subgroups of the retrospective cohorts with interval time no longer than 1 month (G1), longer than 1 month and no longer than 2 months (G2), longer than 2 months and no longer than 3 months (G3), longer than 3 months (G4) are 0.933 (95% Cl: 0.842-1), 0.892 (95% Cl: 0.771-1), 0.854 (95% Cl: 0.623-1), 0.820 (95% Cl: 0.573-1), respectively. The AUCs decrease but not significantly with the increase of the interval time (p>0.05). Therefore, all the patients in the prospective cohort received PET/CT scans within 1 month before the start of the immunotherapy.

Investigating the relationship between clinical characteristics and irSAEs, only the larger dosage and the combination of different antibodies significantly increased the risk of irSAEs, which is consistent with (Patnaik et al. KEYNOTE-021 cohort D. American Society of Clinical Oncology, 2015; Larkin et al. New Engl J Med 2015 373(1):23-34). The target of the checkpoint blockade (PD-L1 or PD-1) is not related to irSAEs in this synchronization analysis based on different clinical trials, which is inconsistent with observations in other trials (Antonia et al. Lancet Oncol. 2016 17(3):299-308; Rizvi et al. J Clin Oncol. 2016 34(25):2969-79), which may be a function of our particular patient population. Notably, the MRS and radiomics nomogram produced higher predictive power for patients who received anti-PD-1 antibodies (FIGS. 3(A3 and B3)). The subsequent prognostic investigation of the radiomics nomogram model, which showed that the patients with a higher risk of irSAEs may have a better prognosis), which is consistent with (Moor et al. J Clin Oncol 2018 36(15_suppl):9067-9067).

A further strength of this study is that PET/CT images were collected from different centers, which had scanners from different manufacturers, models, and reconstruction parameters. Through down (up)-sampling and the application of resampling classification ability in feature selecting, we obtained a stable radiomics score validated by ANOVA test. A moderate concern is that the AUC of the test cohorts were consistently higher than those of the training cohorts. While this may be a product of overfitting, it may also be due to slight differences between our training and testing populations that were not captured demographically or though SUV-matching. Also it is notable that the differences in the AUCs were insignificant (p=0.59). Further independent validation on the PET/CT images of prospective cohort, which were obtained with different equipment, showed there was no significant difference of the MRS between the prospective and retrospective cohorts (p=0.38, Wilcoxon's test), and the AUCs of MRS and the radiomics nomogram could also achieve 0.860 (95% Cl: 0.763-0.957) and 0.877 (95% Cl: 0.782-0.973) on the prospective cohort, both of which decrease the concern of overfitting.

The present study does possess some limitations, however. First, the sample size of patients having irSAEs was small relative to the entire cohort. However, we used the augmented data to keep the balance of the irSAEs and non-irSAEs group. Second, the proportions of the three different treatments are unbalanced, but we used weighted logistic regression to construct the nomogram model. Finally, due to the sample size limitation, deep learning method was not used in current work but will be tried in our future work with the accumulation of additional data. Given that most of the literature discusses the use of single modality images in the training process, we hypothesize that better results will be achieved with the incorporation of our newly constructed fusion images.

### CONCLUSIONS

Pretreatment PET/CT images have the potential to identify the patients who have larger probability to have irSAEs after the start of immunotherapy through the radiomics nomogram model. This model could optimize patient management and treatment plan, as well as alleviate future complications with early interventions after the initiation of immunotherapy pending further external validation with larger cohorts.

TABLE 1
Demographic and Clinical Characteristics of Patients

| | Training Cohort | | | Test Cohort | | |
|---|---|---|---|---|---|---|
| | irSAE | Non-irSAE | P | irSAE | Non-irSAE | P |
| Characteristic | (n = 14) | (n = 83) | Value* | (n = 7) | (n = 42) | Value* |
| Age (y) | | | .20 | | | .11 |
| Mean ± | 69.43 ± 6.72 | 66.35 ± 9.89 | | 73.43 ± 12.95 | 61.85 ± 17.94 | |
| standard | | | | | | |
| deviation | | | | | | |
| Sex, NO. (%) | | | .78 | | | .60 |
| Male | 9 (64.29) | 50 (60.24) | | 4 (57.14) | 25 (59.52) | |
| Female | 5 (35.71) | 33 (39.76) | | 3 (42.86) | 17 (40.48) | |
| BMI (kg/m²) | | | 0.97 | | | 0.52 |
| Mean ± SD | 26.08 ± 4.70 | 26.14 ± 5.49 | | 24.40 ± 4.57 | 25.57 ± 4.37 | |
| ECOG | | 0.76 | | | 0.49 | 0.16 |
| 0 | 3 (21.43) | 24 (28.92) | | 1 (14.29) | 6 (14.29) | |
| 1 | 11 (78.57) | 54 (65.06) | | 5 (71.43) | 34 (80.95) | |
| >=2 | 0 | 5 (6.02) | | 1(14.29) | 2 (4.76) | |
| Distant Metastasis | | | 0.83 | | | 0.66 |
| M0 | 1 (7.14) | 9 (10.84) | | 0 | 1 (2.38) | |
| M1a | 6 (42.86) | 33 (39.76) | | 5 (71.43) | 24 (57.14) | |
| M1b | 7(50.00) | 41 (49.40) | | 2(28.57) | 17 (40.48) | |
| Histology, NO. (%) | | | 0.47 | | | 0.68 |
| ADC | 10 (71.43) | 54 (65.06) | | 5 (71.43) | 27 (64.29) | |
| SCC | 4 (28.57) | 21 (34.94) | | 2 (28.57) | 15 (35.71) | |

Historical treatment, NO. (%)

| SURG | 3 (21.42) | 13 (15.66) | 0.39 | 3 (42.86) | 4 (9.52) | 0.15 |
|---|---|---|---|---|---|---|
| RT | 3 (21.42) | 38 (45.78) | 0.06 | 3 (42.86) | 12 (28.57) | 0.46 |
| Chemo | 6 (42.86) | 55 (66.27) | 0.10 | 4 (57.14) | 25 (59.52) | 0.91 |
| Immunotherapy treatment, NO. (%) | | | .026* | | | 0.024 |
| Anti-PD(L)1 | 4 (28.57) | 56 (67.47) | | 2 (28.57) | 29 (69.05) | |
| Anti-PD(L)1 + | 8(57.14) | 19 (22.89) | | 4 (57.14) | 12 (28.57) | |
| Anti-CTLA-4 | | | | | | |
| Anti-PD(L)1 + | 2(14.29) | 8 (9.64) | | 1 (14.29) | 1 (2.38) | |
| Gefitinib/Chemo | | | | | | |
| Checkpoint inhibitors target | | | 0.65 | | | 0.63 |
| PD-L1 | 5 (35.71) | 35 (42.17) | | 3 (42.86) | 14 (33.33) | |
| PD-1 | 9 (64.29) | 48 (57.83) | | 4 (57.14) | 28 (66.67) | |
| Dosage | | | .017 | | | 0.025 |
| D1 | 5 (35.71) | 56 (67.47) | | 3 (42.86) | 32 (76.19) | |
| D2 | 9 (64.29) | 27 (32.53) | | 4 (57.14) | 10 (23.81) | |
| Smoke, NO. (%) | | | 0.64 | | | 0.35 |
| Non-smoker | 6 (42.86) | 34 (40.96) | | 3 (42.86) | 13 (30.95) | |
| Former-smoker | 8 (57.14) | 44 (53.01) | | 4 (57.14) | 24 (57.14) | |
| Current-smoker | 0 (0.00) | 5 (6.02) | | 0 (0.00) | 5 (11.90) | |
| COPD | | | 0.92 | | | 0.79 |
| NO. (%) | 2 (14.29) | 11(13.25) | | 2 (28.57) | 10 (23.81) | |
| Best Response | | .025* | | <.001 | 0.23 | |
| PR/CR/SD | 13 (92.86) | 60 (72.29) | | 7 (100) | 25 (59.52) | |
| PD | 1 (7.14) | 23 (27.71) | | 0 | 17 (40.48) | |
| Progression-free Survival | | | .021* | | | 0.086 |
| Rate (%) | 35.71 | 66.27 | | 28.57 | 76.19 | |

Time to progression

| Mean(Median) | 14.27(17.22) | 9.49(6.83) | 11.83(10.54) | 8.60 (5.75) |
|---|---|---|---|---|
| Autoimmune disease type, NO. (%) | | | | |
| Colitis/Diarrhea | | 3 (3.09) | | 3 (6.12) |
| Pneumonitis | | 5 (5.15) | | 3 (6.12) |
| Guillain-Barre Syndrome | | 2 (2.06) | | 0 |
| Hepatitis | | 3 (3.09) | | 0 |
| Myalgia | | 1 (1.03) | | 0 |
| Rash | | 0 | | 1 (2.04) |

| | | Prospective Cohort | | |
|---|---|---|---|---|
| | P | irSAE | Non-irSAE | P |
| Characteristic | Value^{†} | (n = 9) | (n = 39) | Value* |
| Age (y) | .24 | | | .068 |
| Mean ± | | 71.78 ± 7.16 | 65.21 ± 9.95 | |
| standard | | | | |
| deviation | | | | |
| Sex, NO. (%) | .47 | | | .22 |
| Male | | 6 (66.67) | 17 (43.59) | |
| Female | | 3 (33.33) | 22 (56.41) | |
| BMI (kg/m²) | 0.41 | | | 0.19 |
| Mean ± SD | | 28.06 ± 6.01 | 25.60 ± 4.78 | |
| ECOG | | | 0.19 | |
| 0 | | 2 (22.22) | 3 (7.69) | |
| 1 | | 7 (77.78) | 35 (89.74) | |
| >=2 | | 0 | 1 (2.56) | |
| Distant Metastasis | 0.81 | | | 0.70 |
| M0 | | 1 (11.11) | 6 (15.38) | |
| M1a | | 4 (44.44) | 18 (46.15) | |
| M1b | | 4 (44.44) | 15 (38.46) | |
| Histology, NO. (%) | 0.49 | | | 0.53 |
| ADC | | 7 (77.78) | 26 (92.31) | |
| SCC | | 2 (22.22) | 13 (33.33) | |
| Historical treatment, NO. (%) | | | | |
| SURG | 0.73 | 4 (44.44) | 23 (58.97) | 0.44 |
| RT | 0.13 | 5 (55.56) | 16 (41.02) | 0.44 |
| Chemo | 0.67 | 7 (77.78) | 32 (82.05) | 0.77 |
| Immunotherapy treatment, NO. (%) | 0.50 | | | 0.14 |
| Anti-PD(L)1 | | 1 (11.11) | 20 (51.28) | |
| Anti-PD(L)1 + | | 2 (22.22) | 2 (5.13) | |
| Anti-CTLA-4 | | | | |
| Anti-PD(L)1 + | | 6 (66.67) | 17 (43.59) | |
| Gefitinib/Chemo | | | | |
| Checkpoint inhibitors target | 0.48 | | | 0.023 |
| PD-L1 | | 0 | 5 (12.82) | |
| PD-1 | | 9 (100) | 34 (87.18) | |
| Dosage | 0.44 | | | 0.600 |
| D1 | | 8 (88.89) | 32 (82.05) | |
| D2 | | 1 (11.11) | 7 (17.95) | |
| Smoke, NO. (%) | 0.19 | | | 0.090 |
| Non-smoker | | 4 (44.44) | 9 (23.08) | |
| Former-smoker | | 4 (44.44) | 30 (76.92) | |
| Current-smoker | | 1 (11.11) | 0 | |
| COPD | 0.12 | | | 0.63 |
| NO. (%) | | 2 (22.22) | 6 (15.38) | |
| Best Response | | 0.061 | | |
| PR/CR/SD | | 8 (88.89) | 24 (61.54) | |
| PD | | 1 (11.11) | 15 (38.46) | |
| Progression-free Survival | 0.38 | | | 0.15 |
| Rate (%) | | 11.11 | 48.72 | |
| Time to progression | | | | |
| Mean(Median) | | 7.19 (5.73) | 8.17(7) | |
| Autoimmune disease type, NO. (%) | 0.98 | | | |
| Colitis/Diarrhea | | | 4 (8.33) | |
| Pneumonitis | | | 4 (8.33) | |
| Guillain-Barre Syndrome | | | 0 | |
| Hepatitis | | | 1 (2.08) | |
| Myalgia | | | 0 | |
| Rash | | | 0 | |

Note.-:
RT is short for radiotherapy;
Chemo is short for chemotherapy;
SD: standard deviation;
P^{†} value is derived from the t-test between irSAEs and non-irSAEs;
P^{‡} is derived from the t-test between training and test cohorts. Data are patient numbers, with percentages in parentheses;
*means P value <.05;
The groups of the variables are mutually exclusive except historical treament. The historical treatment of a patients could include any of the three treatments.

TABLE 2
Performance of Different Models in irSAE Prediction

| | | | | | | |
|---|---|---|---|---|---|---|
| Mo | AUC(95% CI) | ACC(95% CI) | +LR(95% CI) | −LR(95% CI) | AIC | HL test |

Clinical nomogram

| | | | | | | | | | | |
|---|---|---|---|---|---|---|---|---|---|---|
| Training | 0.741 | (0.639-0.843) | 73.20 | (64.95-82.47) | 1.98 | (0.80-4.13) | 0.73 | (0.39-0.71) | 76.92 | 0.43 |
| Test | 0.755 | (0.613-0.897) | 77.55 | (65.31-91.07) | 2.57 | (0.55-8.00) | 0.68 | (0.18-1.13) | 40.23 | 1 |
| Prospective | 0.682 | (0.528-0.836) | 60.42 | (46.93-72.92) | 1.78 | (1.02-3.00) | 0.39 | (0-0.98) | 47.48 | 0.99 |

MRS

| | | | | | | | | | | |
|---|---|---|---|---|---|---|---|---|---|---|
| Training | 0.879 | (0.805-0.952) | 88.66 | (82.47-94.85) | 8.47 | (4.31-22.68) | 0.31 | (0.08-0.59) | 57.45 | 0.48 |
| Test | 0.898 | (0.815-0.980) | 87.76 | (77.55-95.92) | 7.50 | (3.00-42.00) | 0.32 | (0-0.71) | 29.99 | 0.18 |
| Prospective | 0.860 | (0.763-0.957) | 87.50 | (79.17-95.83) | 8.67 | (2.89-Inf) | 0.36 | (0-0.74) | 36.72 | 0.39 |

Radiomics nomogram

| | | | | | | | | | | |
|---|---|---|---|---|---|---|---|---|---|---|
| Training | 0.917 | (0.864-0.976) | 89.69 | (83.50-94.85) | 9.32 | (4.85-27.67) | 0.23 | (0.04-0.47) | 51.22 | 0.79 |
| Test | 0.925 | (0.859-0.991) | 91.84 | (83.67-97.96) | 12.00 | (5.00-Inf) | 0.15 | (0-0.46) | 25.15 | 0.83 |
| Prospective | 0.877 | (0.782-0.973) | 87.50 | (77.08-95.83) | 8.67 | (3.18-Inf) | 0.36 | (0.11-0.70) | 36.72 | 0.84 |

TABLE 3
Dosage Discretization

| immune checkpoint | | Discretization | | | |
|---|---|---|---|---|---|
| blockade antibodies | | 1 | | 2 | |
| Anti-PD-L1 | Durvalumab | <5 | mg/kg/week | >=5 | mg/kg/week |
| | ATEZOlizumab | <=6.67 | mg/kg/week | >6.67 | mg/kg/week |
| | Avelumab | <=5 | mg/kg/week | | |
| Anti-PD-1 | Nivolumab | <=1.5 | mg/kg/week | >1.5 | mg/kg/week |
| | Pembrolizumab | <=1.13 | mg/kg/week | | |
| Anti-CTLA-4 | Tremelimumab | <=0.25 | mg/kg/week | >0.25 | mg/kg/week |
| | ipilimumab | <=0.25 | mg/kg/week | >0.25 | mg/kg/week |

TABLE 4
Logistic regression analysis of risk factors for irSAEs prediction

| | Univariable | | Weighted Multivariable | |
|---|---|---|---|---|
| | Odds Ratio (95% CI) | p | Odds Ratio (95% CI) | p |
| MRS | 7.51 × 10³ | <.001* | 4.20 × 10³ | <.001 |
| | (69.76~8.09 × 10⁵) | | (176.37~9.98 × 10⁴) | |
| SUVmax | 0.95 | 0.34 | | |
| | (0.87~1.05) | | | |
| MTV | 0.99 | 0.27 | | |
| | (0.98~1.00) | | | |
| Tumor Volume | 0.99 | 0.26 | | |
| | (0.98~1.00) | | | |
| Sex | 0.84 | 0.77 | | |
| | (0.26~2.74) | | | |
| Age | 1.04 | 0.26 | | |
| | (0.97~1.11) | | | |
| BMI | 0.998 | 0.97 | | |
| | (0.90~1.11) | | | |
| Histology at | 0.71 | 0.47 | | |
| baseline | (0.28~1.80) | | | |
| Historical SURG | 1.47 | 0.59 | | |
| | (0.36~6.00) | | | |
| Historical RAD | 0.31 | 0.086 | | |
| | (0.08~1.18) | | | |
| Historical Chemo | 0.38 | 0.10 | | |
| | (0.12~1.21) | | | |
| Immunotherapy | 2.30 | 0.032* | 2.40 | 0.005 |
| treatment | (1.07~4.94) | | (1.30~4.43) | |
| Smoke | 0.79 | 0.64 | | |
| | (0.29~2.13) | | | |
| COPD | 1.09 | 0.92 | | |
| | (0.22~5.46) | | | |
| ECOG | 0.925 | 0.86 | | |
| | (0.38~2.22) | | | |
| Distant Metastasis | 1.10 | 0.82 | | |
| | (0.47~2.62) | | | |
| Checkpoint | 1.31 | 0.65 | | |
| inhibitors target | (0.41~4.26) | | | |
| Dose | 3.733 | 0.029* | 2.15 | 0.074 |
| | (1.14~12.22) | | (0.93~4.97) | |
| Constant | | | 0.0014 | <0.001 |

*P value < .05

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

1. A method, comprising:
analyzing ¹⁸F-FDG PET/CT images of a patient to determine PET features, CT features, and Kulbek Leibler Divergence (KLD) features from KLD images generated from the PET and CT images based upon KLD criteria; and
computing a modified radiomic score (MRS) based on the radiomic signature that is predictive of severe immune-related adverse events (irSAE) in the patient, the MRS determined based upon
$$M R S = - A \times CT\_GLN - B \times CT\_GS - C \times CT\_ZP + D \times KLD\_SZLGE - E \times KLD\_SRLGE + F ,$$
where CT_GLN is a grey-level nonuniformity determined from a grey level size zone matrix (GLSZM) indicating a number of groups of connected voxels with a common discretised grey level value and size, CT_GS is a means genometric symmetry determined from a texture spectrum matrix utilizing the CT features, CT_ZP is a zone percentage determined from the GLSZM utilizing the CT features, KLD_SZLGE is a small zone low gray level emphasis determined from the GLSZM utilizing KLD fusion images, and KLD_SRLGE is a short run low gray level emphasis determined from a grey level run length matrix (GLRLM) utilizing the KLD fusion images, and where A, B, C, D, E and F are constants with A in a range from about 0.74 to about 0.78, B in a range from about 0.75 to about 0.79, C in a range from about 0.59 to about 0.63, D in a range from about 1.29 to about 1.33, E in a range from about 0.37 to about 0.41, and F in a range from about 0.93 to about 0.97.

2. The method of claim 1, wherein the MRS is determined based upon
$$M R S = - 0.76 \times CT\_GLN - 0.77 \times CT\_GS - 0.61 \times CT\_ZP + 1.31 \times KLD\_SZLGE - 0.39 \times KLD\_SRLGE + 0.95 .$$

3. The method of claim 1, wherein the CT_GLN is determined by
$$CT\_GLN = \frac{1}{{\sum }_{i = 1}^{{N}_{g}} {\sum }_{j = 1}^{{N}_{z}} {s}_{ij}} {\sum }_{j = 1}^{{N}_{z}} {( {s}_{ij} )}^{2}$$
where sᵢⱼ=s(i,j) is number of zones with discretised grey level i and size j, N_{g} is a number of discretised grey levels, and N_{z} is a maximum zone size of a group of connected voxels.

4. The method of claim 1, wherein the CT_GS is determined by
$$CT\_GS = ( 1 - \frac{1}{3} {\sum }_{j = 1}^{3} ( {\sum }_{i = 0}^{728} \vert {T}_{j} ( i ) - {T}_{j + 3} ( i ) \vert / {\sum }_{i = 0}^{728} 2 {T}_{j} ( i ) ) ) \times 100 \%$$
where Tⱼ is the texture spectrum matrix.

5. The method of claim 1, wherein the KLD_SZLGE is determined by
$$KLD\_SZLGE = \frac{1}{{\sum }_{i = 1}^{{N}_{g}} {\sum }_{j = 1}^{{N}_{z}} {s}_{ij}} {\sum }_{i = 1}^{{N}_{g}} {\sum }_{j = 1}^{{N}_{z}} \frac{{s}_{ij}}{{i}^{2} {j}^{2}}$$
where sᵢⱼ=s(i,j) is number of zones with discretised grey level i and size j, N_{g} is a number of discretised grey levels, and N_{z} is a maximum zone size of a group of connected voxels.

6. The method of claim 1, wherein the KLD_SRLGE is determined by
$$KLD\_SZLGE = \frac{1}{{\sum }_{i = 1}^{{N}_{g}} {\sum }_{j = 1}^{{N}_{z}} {r}_{ij}} {\sum }_{i = 1}^{{N}_{g}} {\sum }_{j = 1}^{{N}_{z}} \frac{{r}_{ij}}{{i}^{2} {j}^{2}}$$
where rᵢⱼ=r(i,j) is a number of occurrences where a discretized grey level i appears in j consecutive neighboring voxels or pixels, N_{g} is a number of discretised grey levels, and Nᵣ is a maximal possible run length along a specific direction.

7. The method of claim 1, wherein the KLD images are constructed by fusing normalized PET and CT pixel-wise image data, I_{PET norm} and I_{CT norm} respectively, as given by
$${I}_{FUSE} = {I}_{PETnorm} + α {I}_{CTnorm} ,$$
$$with$$
$$α = {arg min}_{α ∈ [ 0.4 , 1 ]} ( {\sum }_{i = 0}^{L} {p}_{P E T} ( i ) {log}_{2} \vert \frac{{p}_{PET} ( i )}{{p}_{FUSE} ( i )} \vert + {\sum }_{i = 0}^{L} {p}_{C T} ( i ) {log}_{2} \vert \frac{{p}_{C T} ( i )}{{p}_{F U S E} ( i )} \vert ) ,$$
where P_{PET}, P_{CT} and P_{FUSE} are normalized histograms of the PET, CT, and KLD images, respectively, and L is a number of bins.

8. A non-transitory computer-readable storage device storing computer-executable instructions that when executed cause processing circuitry to at least:
analyze ¹⁸F-FDG PET/CT images of a patient to determine PET features, CT features, and Kulbek Leibler Divergence (KLD) features from KLD images generated from the PET and CT images based upon KLD criteria; and
compute a modified radiomic score (MRS) based on the radiomic signature that is predictive of severe immune-related adverse events (irSAE) in the patient, the MRS determined based upon
$$M R S = - A \times CT\_GLN - B \times CT\_GS - C \times CT\_ZP + D \times KLD\_SZLGE - E \times KLD\_SRLGE + F ,$$
where CT_GLN is a grey-level nonuniformity determined from a grey level size zone matrix (GLSZM) indicating a number of groups of connected voxels with a common discretised grey level value and size, CT_GS is a means genometric symmetry determined from a texture spectrum matrix utilizing the CT features, CT_ZP is a zone percentage determined from the GLSZM utilizing the CT features, KLD_SZLGE is a small zone low gray level emphasis determined from the GLSZM utilizing KLD fusion images, and KLD_SRLGE is a short run low gray level emphasis determined from a grey level run length matrix (GLRLM) utilizing the KLD fusion images, and where A, B, C, D, E and F are constants with A in a range from about 0.74 to about 0.78, B in a range from about 0.75 to about 0.79, C in a range from about 0.59 to about 0.63, D in a range from about 1.29 to about 1.33, E in a range from about 0.37 to about 0.41, and F in a range from about 0.93 to about 0.97.

9. The non-transitory computer-readable storage device of claim 8, wherein the MRS is determined based upon
$$M R S = - 0.76 \times CT\_GLN - 0.77 \times CT\_GS - 0.61 \times CT\_ZP + 1.31 \times KLD\_SZLGE - 0.39 \times KLD\_SRLGE + 0 \text{.95} .$$

10. The non-transitory computer-readable storage device of claim 8, wherein the CT_GLN is determined by
$$CT\_GLN = \frac{1}{{\sum }_{i = 1}^{{N}_{g}} {\sum }_{j = 1}^{{N}_{z}} {s}_{ij}} {\sum }_{j = 1}^{{N}_{z}} {( {s}_{ij} )}^{2}$$
where sᵢⱼ=s(i,j) is number of zones with discretised grey level i and size j, N_{g} is a number of discretised grey levels, and N_{z} is a maximum zone size of a group of connected voxels.

11. The non-transitory computer-readable storage device of claim 8, wherein the CT_GS is determined by
$$CT\_GS = ( 1 - \frac{1}{3} {\sum }_{j = 1}^{3} ( {\sum }_{i = 0}^{728} \vert {T}_{j} ( i ) - {T}_{j + 3} ( i ) \vert / {\sum }_{i = 0}^{728} 2 {T}_{j} ( i ) ) ) \times 100 \%$$
where Tⱼ is the texture spectrum matrix.

12. The non-transitory computer-readable storage device of claim 8, wherein the KLD_SZLGE is determined by
$$KLD\_SZLGE = \frac{1}{{\sum }_{i = 1}^{{N}_{g}} {\sum }_{j = 1}^{{N}_{z}} {s}_{ij}} {\sum }_{i = 1}^{{N}_{g}} {\sum }_{j = 1}^{{N}_{z}} \frac{{s}_{ij}}{{i}^{2} {j}^{2}}$$
where sᵢⱼ=s(i,j) is number of zones with discretised grey level i and size j, N_{g} is a number of discretised grey levels, and N_{z} is a maximum zone size of a group of connected voxels.

13. The non-transitory computer-readable storage device of claim 8, wherein the KLD_SRLGE is determined by
$$KLD\_SZLGE = \frac{1}{{\sum }_{i = 1}^{{N}_{g}} {\sum }_{j = 1}^{{N}_{r}} {r}_{ij}} {\sum }_{i = 1}^{{N}_{g}} {\sum }_{j = 1}^{{N}_{r}} \frac{{r}_{ij}}{{i}^{2} {j}^{2}}$$
where rᵢⱼ=r(i,j) is a number of occurrences where a discretized grey level i appears in j consecutive neighboring voxels or pixels, N_{g} is a number of discretised grey levels, and Nᵣ is a maximal possible run length along a specific direction.

14. The non-transitory computer-readable storage device of claim 8, wherein the KLD images are constructed by fusing normalized PET and CT pixel-wise image data, I_{PET norm} and I_{CT norm} respectively, as given by
$${I}_{FUSE} = {I}_{PETnorm} + α {I}_{CTnorm} ,$$
$$with$$
$$α = {arg min}_{α ∈ [ 0.4 , 1 ]} ( {\sum }_{i = 0}^{L} {p}_{P E T} ( i ) {log}_{2} \vert \frac{{p}_{PET} ( i )}{{p}_{FUSE} ( i )} \vert + {\sum }_{i = 0}^{L} {p}_{C T} ( i ) {log}_{2} \vert \frac{{p}_{C T} ( i )}{{p}_{F U S E} ( i )} \vert ) ,$$
where P_{PET}, P_{CT} and P_{FUSE} are normalized histograms of the PET, CT, and KLD images, respectively, and L is a number of bins.
